(19) United States
(12) Patent Application Publication
(10) Pub. No.: US 2009/0215487 A1
(43) Pub. Date: Aug. 27, 2009

(54) FLEXIBLE ELECTRO ACOUSTIC ACTUATOR WITH AN ANTENNA

(76) Inventors: En-Yi Chang, Taipei (TW); Ting-Yu Hsieh, Hsinchu (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/360,032

(22) Filed: Jan. 26, 2009

(30) Foreign Application Priority Data
Feb. 21, 2008 (TW) 097106012

(51) Int. Cl. H04M 1/00; H04B 1/38

(52) U.S. Cl. 455/550.1; 455/90.2

(57) ABSTRACT

A flexible electro acoustic actuator with an antenna is provided. The flexible electro acoustic actuator is formed with separate layers of carrier, acoustic oscillation component, intermediate component, and metal electro-conductive component, and characterized by using the metal electro-conductive component to form an antenna transceiver for receiving/sending electromagnetic signals, thereby enabling the flexible electro acoustic actuator to output multimedia sound effects as well as receive/send communication signals.

### BACKGROUND OF THE INVENTION

1. Field of the Invention

This invention generally relates to an electronic device with an antenna, particularly to an electronic device integrating a flexible electro acoustic actuator with an antenna, and more specifically, a flexible electro acoustic actuator with an antenna, which is capable of outputting multimedia sound effects as well as receiving/sending communication signals.

2. Description of Related Art

With fast development of electronic products, almost everyone has at least one mobile phone for communicating with the outside world. Owing to advanced technology and users' demand, the modern trend of mobile phones is towards thin, light weighted, and attractive appearance with more powerful functions. Also, owing to prosperous development in various electronic devices and wide-development of numerous communication networks, a variety of portable electronic devices have more and more sophisticated functions, for instance, all up-to-date personal digital assistant (PDA) are equipped with general packet radio service (GPRS) for surfing the Internet as well as a global positioning system (GPS) for providing navigation in driving a vehicle, and some other electronic devices are even equipped with a smart phone system. However, to perform each of the aforesaid sophisticated functions, an antenna is essentially required for radiating and receiving wireless signals. In addition, the portable electronic device must adopt an electro acoustic actuator to produce acoustics for enabling the mobile phone user to take a phone call, and also providing the user with video/audio entertainment functions.

Regarding the trend toward thin and lightweight appearance, the PDA cellphone or the smart phone provides limited space for assembling all components of the mobile phone therein, therefore, electronic components applied therein must be miniaturized and sophisticated. Since all conventional build-in antennas are adopting chip antennas or a large-size metal antenna, applicable area for the antennas is restricted in order to prevent the antennas and other metal components from interfering with each other, or to prevent the antennas from being blocked by other metal components. Also, since up-to-date portable electronic devices with multiple functions are equipped with multiple antennas, one can hardly find a proper location for installing the multiple antennas if the conventional mode of antenna installation is adopted.

Furthermore, when a plurality of antennas and a flexible electro acoustic actuator are to be allocated to an electronic device, it is likely that the electro acoustic actuator will block the antennas from transmitting and/or receiving wireless signals. Hence, a highly urgent issue in the industry involves providing a technique for solving the drawbacks of the prior art mentioned above.

### SUMMARY OF THE INVENTION

In view of the disadvantages of the prior art mentioned above, it is a primary objective of the present invention to provide a flexible electro acoustic actuator with an antenna, which is capable of outputting multimedia sound effects as well as receiving/sending communication signals.

To achieve the aforementioned and other objectives, a flexible electro acoustic actuator with an antenna is provided according to the present invention; the power supply device is applicable to electronic device and comprises: a carrier having a first bonding surface and a second bonding surface opposite to the first bonding surface, wherein the first bonding surface is coupled to the portable electronic device; an acoustic oscillation component coupled to the carrier and provided with an acoustic source signal input point for producing acoustics; an intermediate component coupled to the acoustic oscillation component, thereby forming a tensile stress space; a metal electro-conductive component coupled to the intermediate component and provided with a grounding point shared by an acoustic source signal and an antenna and at least a high frequency power and antenna feed-in point, thereby forming an antenna transceiver for receiving/sending electromagnetic signals.

In summary, the flexible electro acoustic actuator with an antenna of the present invention is mainly formed with separate layers of carrier, acoustic oscillation component, intermediate component, and metal electro-conductive component, wherein the metal electro-conductive component forms an antenna transceiver for receiving/sending electromagnetic signals, thereby enabling the flexible electro acoustic actuator with an antenna of the present invention to output multimedia sound effects as well as receive/send communication signal via the antenna.

### BRIEF DESCRIPTION OF DRAWINGS

The present invention can be more fully understood by reading the following detailed description of the preferred embodiments, with reference made to the accompanying drawings, wherein:

FIG. 1 is an analytic architecture diagram of a flexible electro acoustic actuator with an antenna of the present invention;

FIG. 2 is an assembled architecture diagram of the flexible electro acoustic actuator with an antenna of the present invention;

FIG. 3 is a diagram illustrating a first embodiment of the flexible electro acoustic actuator with an antenna of the present invention;

FIG. 4 is a table illustrating experimental measurement on reflection loss of the flexible electro acoustic actuator with an antenna of the present invention;

FIGS. 5 through 7 are distribution maps of a radiation field of the flexible electro acoustic actuator with an antenna of the present invention; and

FIG. 8 is a table showing addition of the gains of applied vertical polarization and horizontal polarization of the flexible electro acoustic actuator with an antenna of the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

In a preferable embodiment, an antenna can be a multipole or multi-band antenna, or a planar inverted-F antenna (PIFA), and the application scope of the antenna covers various communication operation frequency bands corresponding to wireless local area network (WLAN), Bluetooth, Wi-Fi, global positioning system (GPS), global system for mobile communication (GSM), CDMA2000, WCDMA, etc., and length of the antenna depends on the wavelength of an electromagnetic signal, e.g. the length of the antenna is about a quarter of the wavelength of the electromagnetic signal; meanwhile, an electronic device, to which the flexible electro acoustic actuator with an antenna of the present invention is applied, can be a personal digital assistant (PDA) or a smart phone, but not restricted to the PDA or the smart phone, namely the present invention is applicable to any electronic device that requires an antenna and provides a function of voice messaging.

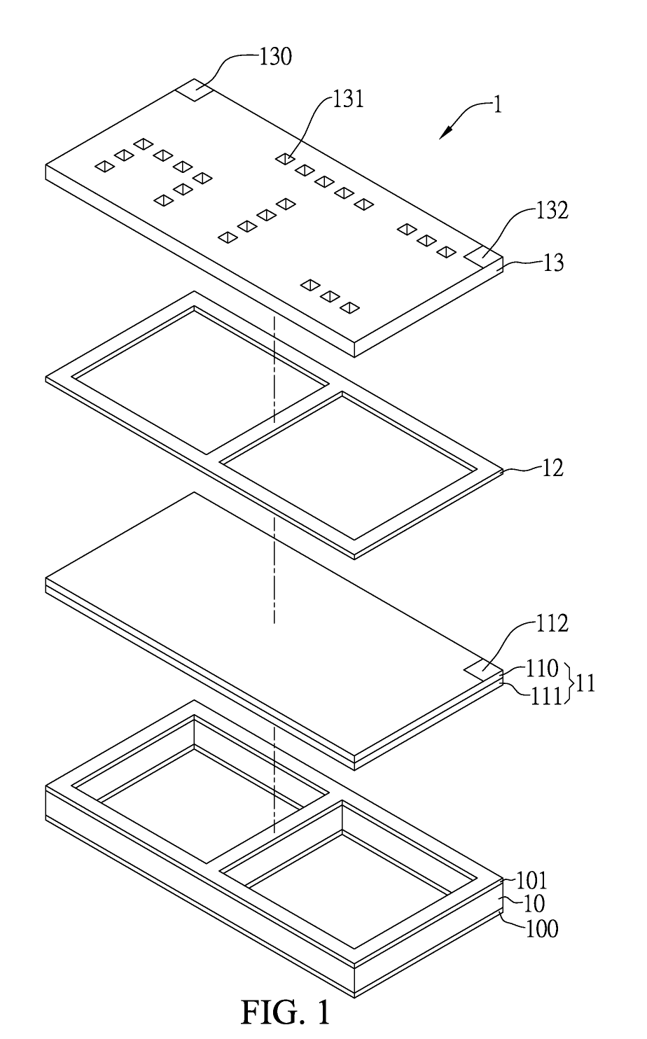

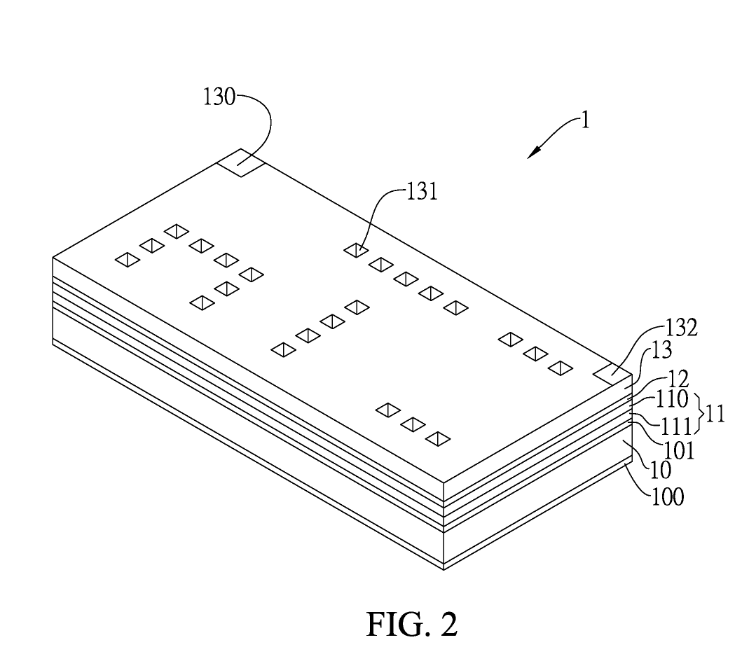

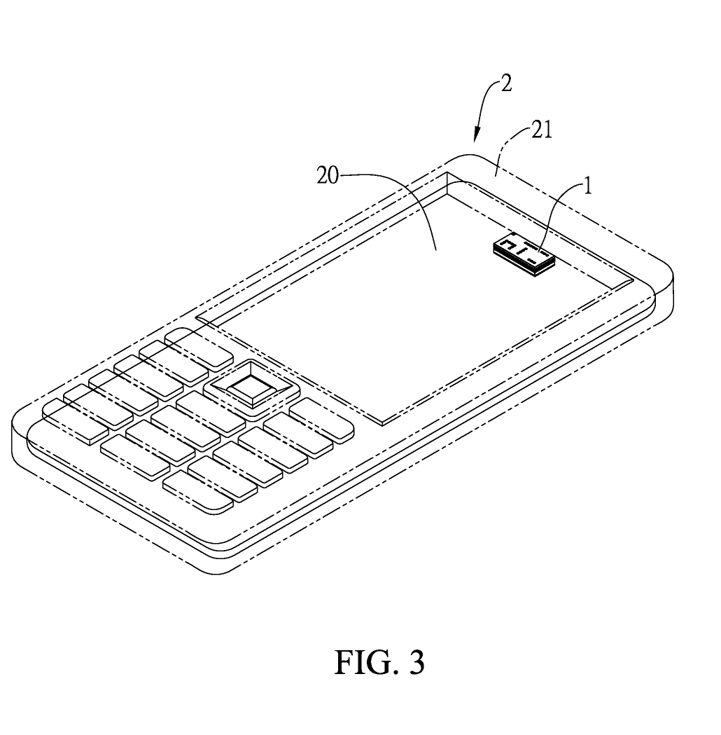

Please refer to FIGS. 1 through 3, wherein FIGS. 1 and 2 are an analytic architecture diagram and an assembled architecture diagram of the flexible electro acoustic actuator with an antenna of the present invention respectively; and FIG. 3 is a diagram illustrating a first embodiment of the flexible electro acoustic actuator with an antenna of the present invention.

The flexible electro acoustic actuator with an antenna 1, which is disposed inside a portable electronic device 2, e.g. a mobile phone, comprises a carrier 10, an acoustic oscillation component 11, an intermediate component 12, and a metal electro-conductive component 13. The carrier 10, e.g. a soft plastic component, has a first bonding surface 100 and a second bonding surface 101 opposite to the first bonding surface 100, wherein the first surface 100 is coupled to a circuit board 20 of the portable electronic device 2, e.g. the mobile phone. The acoustic oscillation component 11 is formed with a plastic vibration membrane 110 and a metal thin film 111 and is coupled to the second bonding surface 101 of the carrier 10, e.g. the soft plastic component, and is for producing acoustics, wherein the acoustic oscillation component 11 also has an acoustic source signal input point 112. The intermediate component 12, e.g. a double-sided adhesive tape, is coupled to the acoustic oscillation component 11 for forming a tensile stress space. The metal electro-conductive component 13, e.g. an electro-conductive metal thin plate, is coupled to the double-sided adhesive tape of the intermediate component 12, has a grounding point 132 shared by an acoustic source signal and an antenna, and has a high frequency power and antenna feed-in point 130 and a plurality of acoustic apertures 131, thereby forming an antenna transceiver for receiving/ sending electromagnetic signals, such as communication operation frequency band of the global positioning system (GPS), wherein the metal electro-conductive component 13 is a radiation main body of the antenna, meanwhile the portable electronic device 2, e.g. the mobile phone, further comprises a circuit board 20 and electronic device case 21, the antenna is disposed on the circuit board 20 or the electronic device case 21, and the antenna can be disposed into a mechanism component on the circuit board 20 or the electronic device case 21 by using any available space and by means of a male female mold surface of the electronic device case 21 or embedded rejection, thereby enabling the flexible electro acoustic actuator with an antenna of the present invention to output multimedia sound effects as well as receive/send communication signals.

Generally, electronic device with multiple functions needs many antennas for providing various modes of communication to receive/send communication signals, also current trend of electronic devices is towards miniaturization, thin and light-weighted appearance, therefore, by using the metal electro-conductive component 13 as the radiation main body for the antenna, the flexible electro acoustic actuator with an antenna of the present invention is capable of not only saving inner space of the electronic device but also avoiding drawbacks of the prior art, wherein a conventional flexible electro acoustic actuator and an antenna are separately disposed and consequently causing the conventional flexible electro acoustic actuator to interrupt the antenna from receiving signals.

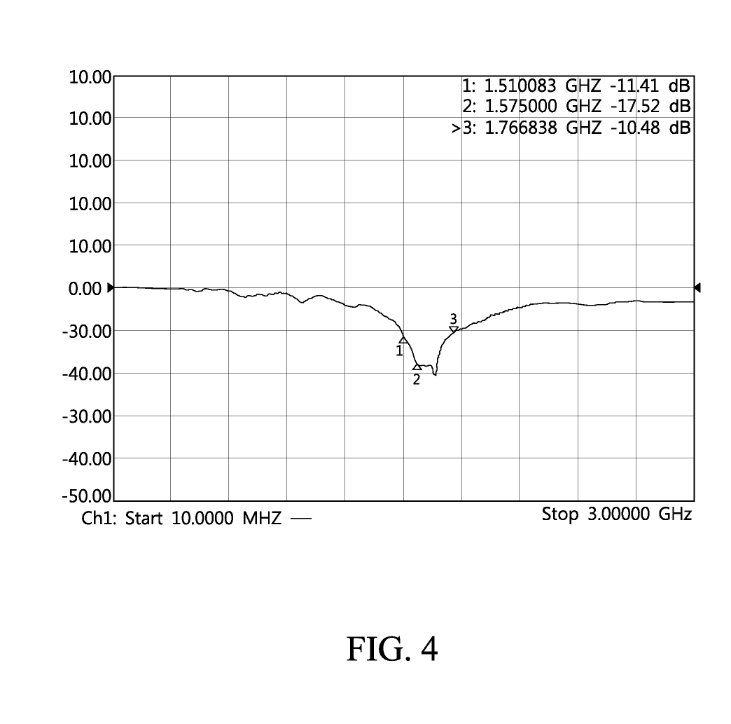

Please refer to FIG. 4, which is a table illustrating experimental measurement on reflection loss of the flexible electro acoustic actuator with an antenna of the present invention, wherein y-axis shows reflection loss value, while x-axis shows operation frequency. As shown in the drawing, on global positioning system (GPS) 1575 MHz experimental measurement, the flexible electro acoustic actuator with an antenna of the present invention has a reflection loss value −17.52 dB, thereby satisfying practical application demand of the GPS communication operation frequency band.

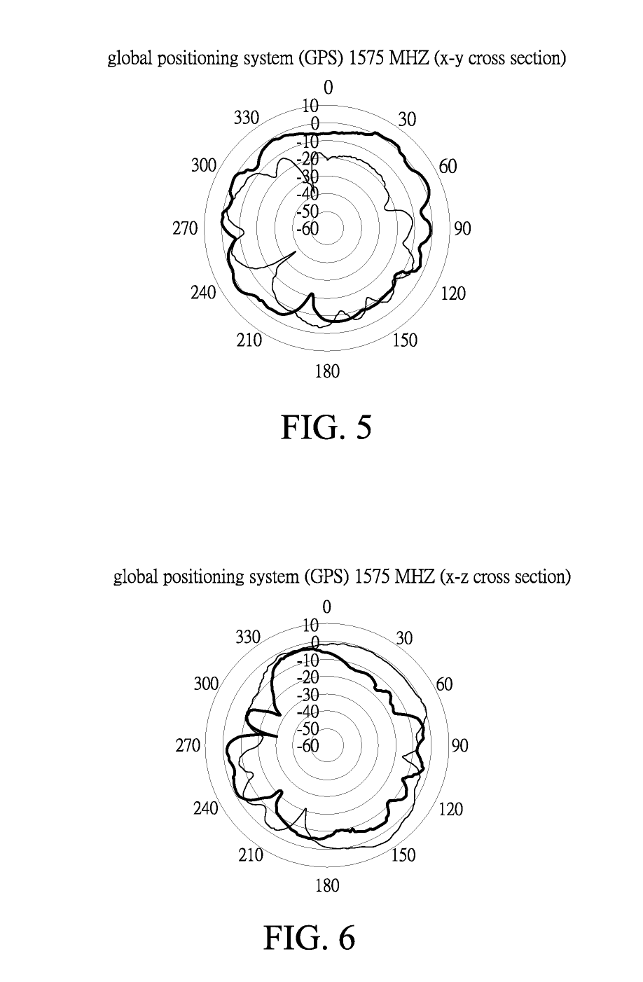

Theoretically speaking, antenna performance is commonly evaluated in terms of two-dimensional cross-sections of a three-dimensional radiation field, and an idealized antenna is an isotropic antenna; in other words, all radiation intensity received by the idealized antenna in the air are the same regardless of directions. Therefore, in a circumstance without any interference, the 3-D radiation field of an idealized antenna should be spherical, and the three different 2-D cross-sections should be in round shape. Referring to FIGS. 5 through 7, which are distribution maps of a radiation field of the flexible electro acoustic actuator with an antenna of the present invention, while testing an electronic device applying the antenna of the present invention on radiation intensity at GPS 1757 MHz frequency, X-Y, Y-Z, X-Z cross-sections of a radiation field of the antenna of the present invention are approximately in round shape as shown in the drawings, indicating that the flexible electro acoustic actuator with an antenna has better transmission performance, meanwhile the antenna has multimedia sound effects, thereby solving limited space conflict of a flexible electro acoustic actuator and an antenna, and further saving space as well as lowering production cost.

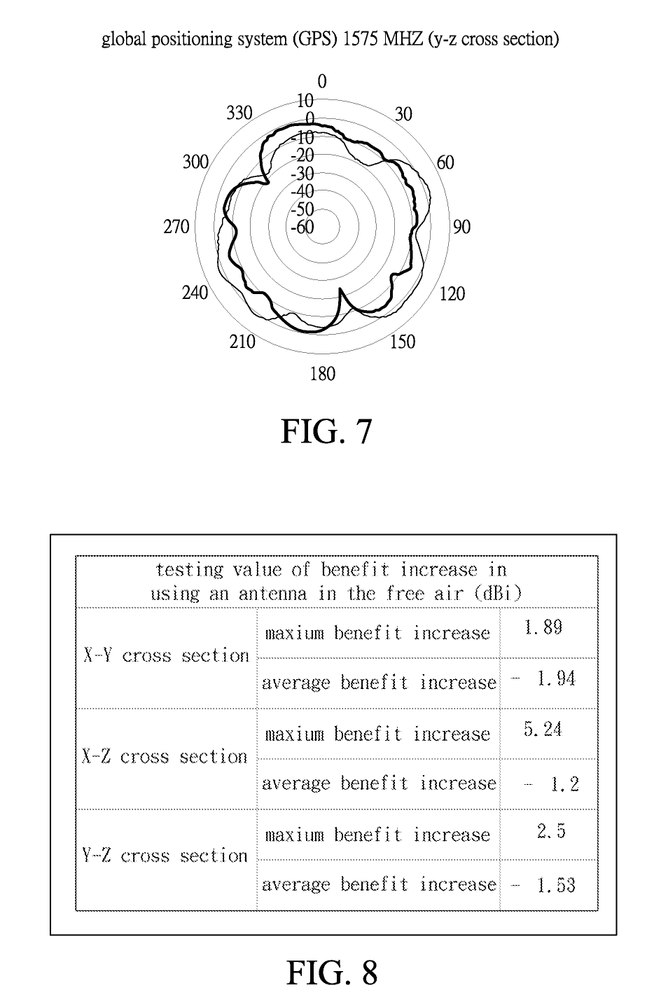

Please refer to FIG. 8, which is a table showing addition of gains of applied vertical polarization and horizontal polarization of the flexible electro acoustic actuator with an antenna of the present invention, the table shows the measurement outcome of testing at GPS 1575 MHz. As shown in the table, the flexible electro acoustic actuator with an antenna 1 has maximum gain of 1.89 dBi and average gain of −1.94 dBi on X-Y cross-section, maximum gain of 5.24 dBi and average gain of −1.2 dBi on X-Z cross-section, and maximum gain of 2.5 dBi and average gain of −1.53 dBi on Y-Z cross-section, which are consistent with the gain of a typical monopole antenna applied to a portable electronic device, e.g. mobile phone. Accordingly, by using the metal electro-conductive component 13 of the flexible electro acoustic actuator 1 to function as an antenna for receiving/sending electromagnetic signals, the antenna not only operates normally but also is unaffected by sound produced by the flexible electro acoustic actuator 1, thereby preventing the sound from further affecting the metal electro-conductive component 13 to send/receive signals.

In view of the above, the flexible electro acoustic actuator with an antenna of the present invention is characterized by being applicable to portable electronic device and mainly comprising a carrier, an acoustic oscillation component, an intermediate component, and a metal electro-conductive component. The carrier has a first bonding surface and a second bonding surface opposite to the first bonding surface. The first bonding surface is coupled to the portable electronic device. The acoustic oscillation component is coupled to the carrier and provided with an acoustic source signal input point for producing acoustics. The intermediate component is coupled to the acoustic oscillation component to form a tensile stress space. The metal electro-conductive component is coupled to the intermediate component and provided with a grounding point shared by an acoustic source signal and an antenna and at least a high frequency power and antenna feed-in point, thereby forming an antenna transceiver for receiving/sending electromagnetic signals, and enabling the flexible electro acoustic actuator to output multimedia sound effects and receive/send communication signals.

The foregoing descriptions of the detailed embodiments are only illustrated to disclose the features and functions of the present invention and not restrictive of the scope of the present invention. It should be understood to persons skilled in the art that all modifications and variations made in the preferred embodiments of the present invention according to the spirit and principle embodied in the disclosure of the present invention should fall within the scope of the appended claims.

What is claimed is:

1. A flexible electro acoustic actuator with an antenna, which is applied to a portable electronic device, comprising:
a carrier having a first bonding surface and a second bonding surface opposite to the first bonding surface, wherein the first bonding surface is coupled to the portable electronic device;
an acoustic oscillation component coupled to the carrier and provided with an acoustic source signal input point for producing acoustics;
an intermediate component coupled to the acoustic oscillation component and configured for forming a tensile stress space; and
a metal electro-conductive component coupled to the intermediate component and provided with a grounding point shared by an acoustic source signal and an antenna and a high frequency power and antenna feed-in point, thereby forming an antenna transceiver for receiving/sending electromagnetic signals.

2. The flexible electro acoustic actuator with an antenna of claim 1, wherein the antenna uses the metal electro-conductive component of the flexible electro acoustic actuator as a radiation main body.

3. The flexible electro acoustic actuator with an antenna of claim 2, wherein the antenna is formed on the metal electro-conductive component by means of etching or a printing circuit.

4. The flexible electro acoustic actuator with an antenna of claim 3, wherein the antenna is a planar inverted-F antenna (PIFA).

5. The flexible electro acoustic actuator with an antenna of claim 4, wherein the antenna is a planar antenna, a multipole antenna, or a multi-band antenna.

6. The flexible electro acoustic actuator with an antenna of claim 1, wherein a length of the antenna is a quarter of a wavelength of an electromagnetic signal approximately.

7. The flexible electro acoustic actuator with an antenna of claim 1, wherein an operating frequency of the antenna ranges from 200 MHz to 6 GHz.

8. The flexible electro acoustic actuator with an antenna of claim 1, wherein the portable electronic device with a build-in antenna further comprises a circuit board.

9. The flexible electro acoustic actuator with an antenna of claim 1, wherein the portable electronic device further comprises an electronic device case.

10. The flexible electro acoustic actuator with an antenna of claim 8 or 9, wherein the antenna is disposed on the circuit board or the electronic device case.

11. The flexible electro acoustic actuator with an antenna of claim 9, wherein using any available space, the antenna is disposed inside a mechanism component by means of a male female mold surface of the electronic device case or embedded rejection.

12. The flexible electro acoustic actuator with an antenna of claim 1, wherein the acoustic oscillation component is formed with a plastic vibration membrane and a metal thin film.

13. The flexible electro acoustic actuator with an antenna of claim 1, wherein the carrier is a soft plastic component.

14. The flexible electro acoustic actuator with an antenna of claim 1, wherein the electromagnetic signal is attributable to one of communication operation frequency bands of wireless local area network (WLAN), Bluetooth, global positioning system (GPS), wireless fidelity (Wi-Fi), global system for mobile communication (GSM), Wideband Code Division Multiple Access (WCDMA), and Worldwide Interoperability for Microwave Access (WiMax).

15. The flexible electro acoustic actuator with an antenna of claim 1, wherein the portable electronic device is one selected from the group consisting of mobile phone, smart phone, notebook computer, portable navigation device (PND), and any other electronic device requiring the antenna.

16. The flexible electro acoustic actuator with an antenna of claim 1, wherein the metal electro-conductive component further comprises a plurality of acoustic apertures.

17. The flexible electro acoustic actuator with an antenna of claim 1, wherein the metal electro-conductive component is formed with an electro-conductive metal thin plate.

18. The flexible electro acoustic actuator with an antenna of claim 1, wherein the grounding point is shared by the acoustic source signal and the antenna.
